(19) United States
(12) Patent Application Publication
(10) Pub. No.: US 2018/0201013 A1
(43) Pub. Date: Jul. 19, 2018

(54) LIQUID EJECTING APPARATUS

(71) Applicant: SEIKO EPSON CORPORATION, Tokyo (JP)

(72) Inventors: Takuya OKINA, Shiojiri (JP); Izumi NOZAWA, Matsumoto (JP); Eiichiro WATANABE, Matsumoto (JP); Fumiya TAKINO, Shiojiri (JP)

(21) Appl. No.: 15/847,537

(22) Filed: Dec. 19, 2017

(30) Foreign Application Priority Data
Jan. 13, 2017 (JP) 2017-003966

(51) Int. Cl. B41J 2/045

(52) U.S. Cl. CPC B41J 2/04586

(57) ABSTRACT

The liquid ejecting apparatus includes a liquid ejecting head configured to eject liquid from the nozzles, a supply flow path configured to supply liquid to the liquid ejecting head, and a pressurizing mechanism that has a liquid chamber disposed in the middle of the supply flow path and a pressure-receiving portion constituting a portion of a wall of the liquid chamber. The pressurizing mechanism is configured to pressurize a region downstream of the liquid chamber when the pressure-receiving portion receives an external force, The liquid chamber is arranged side by side with the liquid ejecting head in a state where the pressure-receiving portion is positioned on an opposite side of the liquid ejecting head when viewed in plan view from above.

### BACKGROUND

### 1. Technical Field

The present invention relates to a liquid ejecting apparatus, such as a printer.

### 2. Related Art

One example of a liquid ejecting apparatus is a liquid discharging apparatus that has an ink chamber disposed directly above a liquid discharging head (for example, JP-A-2015-193213). The ink chamber is formed of, and enclosed by, a recess having an upward-facing opening and a flexible member that covers the recess. The liquid discharging apparatus is configured to pressurize the inside of the liquid discharging head by bending and displacing the flexible member downward.

In the liquid discharging apparatus, components such as the liquid discharging head, the ink chamber, and a mechanism for bending and displacing the flexible member are arranged vertically in an overlapping manner. This imposes restrictions on component arrangement.

### SUMMARY

An advantage of some aspects of the invention is that a liquid ejecting apparatus providing a higher degree of freedom in component arrangement is provided.

A liquid ejecting apparatus according to an aspect of the invention includes a liquid ejecting head that has nozzles and is formed to eject liquid from the nozzles, a supply flow path that is configured to supply the liquid to the liquid ejecting head, and a pressurizing mechanism that has a liquid chamber disposed in the middle of the supply flow path and a pressure-receiving portion constituting a portion of a wall of the liquid chamber, the pressurizing mechanism being configured to pressurize a region downstream of the liquid chamber when the pressure-receiving portion receives an external force. In the liquid ejecting apparatus, the liquid chamber is arranged side by side with the liquid ejecting head in a state where the pressure-receiving portion is positioned on an opposite side of the liquid ejecting head when viewed in plan view from above.

### BRIEF DESCRIPTION OF THE DRAWINGS

The invention will be described with reference to the accompanying drawings, wherein like numbers reference like elements.

FIG. 1 is a view illustrating a general configuration of one embodiment of a liquid ejecting apparatus.

FIG. 2 is a plan view schematically illustrating an arrangement of major components of the liquid ejecting apparatus in FIG. 1.

FIG. 3 is a cross-sectional view illustrating a pressure regulation mechanism included in the liquid ejecting apparatus in FIG. 1.

FIG. 4 is an enlarged cross-sectional view illustrating a region indicated by the dot-and-dash line in FIG. 3.

FIG. 5 is a cross-sectional view illustrating a modification example of the part indicated by the dot-and-dash line in FIG. 3.

FIG. 6 is a view illustrating a general configuration of a first modification example of the liquid ejecting apparatus.

FIG. 7 is a view illustrating a general configuration of a second modification example of the liquid ejecting apparatus.

FIG. 8 is a front view illustrating major components of the liquid ejecting apparatus in FIG. 7.

### DESCRIPTION OF EXEMPLARY EMBODIMENTS

Embodiments of the liquid ejecting apparatus will be described with reference to the drawings. An example of the liquid ejecting apparatus is an ink jet type printer that performs recording (i.e., printing) by ejecting ink, which is an example of a liquid, onto a medium, such as a sheet of paper.

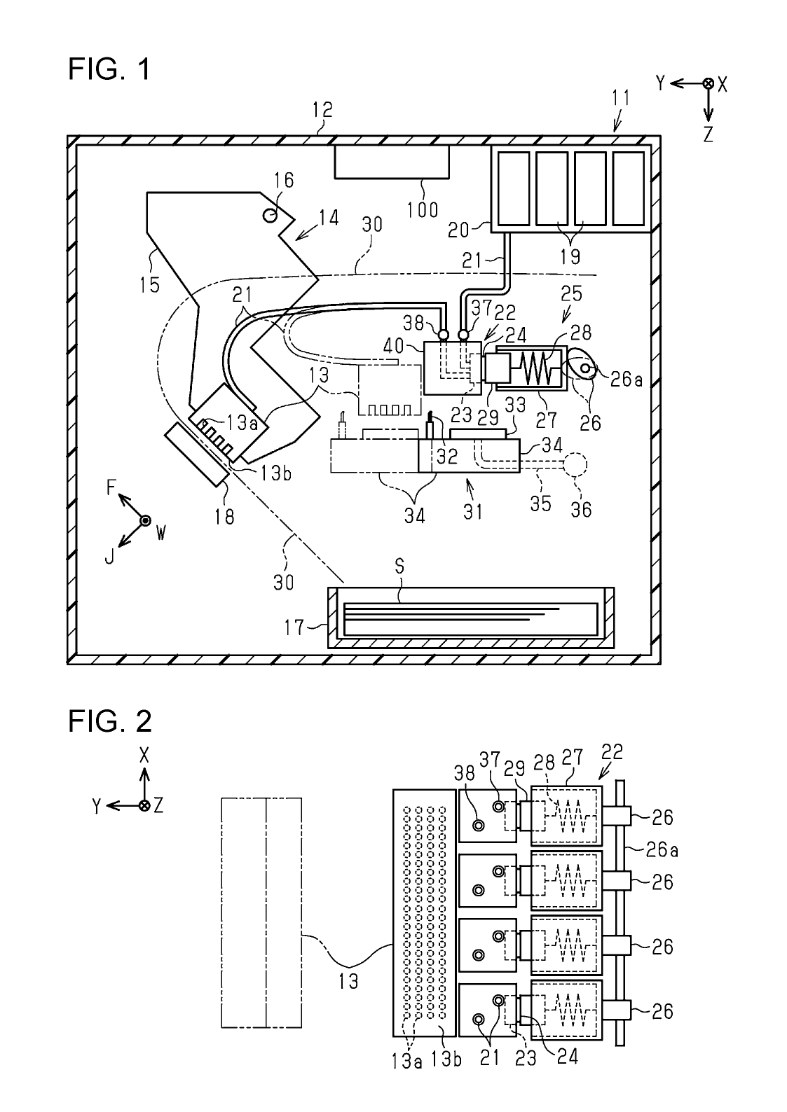

As illustrated in FIG. 1, a liquid ejecting apparatus 11 includes a housing 12, a liquid ejecting head 13 that ejects liquid within the housing 12, a maintenance unit 31 that performs maintenance operations for the liquid ejecting apparatus 11. The liquid ejecting head 13 has a plurality of nozzles 13a and a nozzle-opening surface 13b on which the nozzles 13a open. The liquid ejecting head 13 is configured to eject liquid from the nozzles 13a onto a medium S.

In the embodiment, a vertically downward direction is represented by the gravity direction Z, whereas two horizontal directions that are different from each other are represented by the first direction X and the second direction Y. The liquid ejecting apparatus 11 may include a displacement mechanism 14 that displaces the liquid ejecting head 13, a cassette 17 that contains a plurality of media S, a supporting platform 18 that supports a medium S that is fed from the cassette 17, a moving mechanism 34, and a control unit 100. The moving mechanism 34 moves the maintenance unit 31 in the second direction Y and in the direction opposite thereto. The control unit 100 controls operation of the liquid ejecting head 13, the displacement mechanism 14, the maintenance unit 31, and the moving mechanism 34.

An installation unit 20 is preferably disposed inside or outside the housing 12 (disposed inside the housing 12 in the embodiment), and one or a plurality of liquid containers 19 (four in the embodiment) are installed in the installation unit 20. A liquid container 19 is a container for containing liquid that is supplied to the liquid ejecting head 13. The liquid container 19 may be an attachable/detachable cartridge or a tank into which liquid can be injected. If the liquid container 19 is installed above the liquid ejecting head 13, liquid contained in the liquid container 19 can be supplied to the liquid ejecting head 13 by utilizing a pressure head difference.

The liquid ejecting apparatus 11 includes a supply flow path 21 and a pressurizing mechanism 22. The supply flow path 21 is disposed so as to supply liquid to the liquid ejecting head 13. The pressurizing mechanism 22 has a liquid chamber 23 that is disposed midway in the supply flow path 21 and a pressure-receiving portion 24 that constitutes part of a wall of the liquid chamber 23. The pressurizing mechanism 22 is formed so as to pressurize the region downstream of the liquid chamber 23 when the pressure-receiving portion 24 receives an external force.

A liquid chamber 23 is arranged adjacent to the liquid ejecting head 13 in such a manner that when viewed in plan view, the pressure-receiving portion 24 is disposed on a side opposite to the liquid ejecting head 13. In this case, the pressure-receiving portion 24, the liquid chamber 23, and the liquid ejecting head 13 are arranged in a row in one direction (for example, in the second direction Y) when viewed in plan view (see also FIG. 2). The liquid chamber 23, the pressure-receiving portion 24, and the liquid ejecting head 13 may be disposed on the same level or on different levels.

The pressurizing mechanism 22 preferably includes a drive mechanism 25 that is capable of applying an external force to the pressure-receiving portion 24. The drive mechanism 25 is preferably disposed on a side opposite to the liquid chamber 23 with respect to the pressure-receiving portion 24 when viewed in plan view. The drive mechanism 25 includes, for example, a cam 26 that can rotationally move about the cam shaft 26a, a slider 27 that is pushed by the cam 26, an urging member 28 that has one end fixed to the slider 27, and a pressing member 29 that is attached to the other end of the urging member 28. The drive mechanism 25 is formed such that by rotating the cam 26, the slider 27 and the pressing member 29 are moved toward the pressure-receiving portion 24 and thereby an urging force of the urging member 28 is applied, as a pressing force (external force), to the pressure-receiving portion 24.

In this case, it is preferable that the cam 26, the urging member 28, the pressing member 29, the pressure-receiving portion 24, and the liquid chamber 23 be arranged in a row in one direction (for example, in the second direction Y). Here, a transport path 30 for media S extends in one direction (in the direction opposite to the second direction Y in the embodiment). Thus, if the transport path 30 and the above components that are arranged in a row in one direction overlap each other in the vertical direction, the space inside the housing 12 can be utilized efficiently. However, the direction in which these components are arranged in a row is not limited to the second direction Y. The components may be disposed such that when viewed in plan view, at least portions of the components are arranged in a row in one direction, in other words, portions of two different components may overlap each other vertically.

The displacement mechanism 14 includes a retaining member 15 that holds the liquid ejecting head 13 and a pivot shaft 16. The displacement mechanism 14 rotates the retaining member 15 about the pivot shaft 16, which causes the liquid ejecting head 13 to move between a recording position (indicated by the solid line in FIG. 1) and a standby position (indicated by the dash-dot-dot line in FIG. 1). The standby position is provided closer to the liquid chamber 23 than to the recording position, preferably between the pressure-receiving portion 24 and the recording position, when viewed in plan view.

At least a portion of the supply flow path 21 that connects the liquid chamber 23 to the liquid ejecting head 13 is preferably formed of a tube that can be displaced in accordance with movement of the liquid ejecting head 13. The supply flow path 21 formed of a tube preferably extends in the second direction Y from the liquid chamber 23 (in FIG. 1, toward the left-hand side of the housing that is opposite to the right-hand side where the pressurizing mechanism 22 is located). The supply flow path 21 is subsequently bent so as to change from the second direction Y to the opposite direction and is connected to the top of the liquid ejecting head 13.

In the case that the liquid ejecting head 13 moves between the recording position and the standby position, the nozzle-opening surface 13b is inclined with respect to the horizontal plane when the liquid ejecting head 13 is at the recording position. When it is at the standby position, the nozzle-opening surface 13b preferably becomes closer to horizontal than it is at the recording position. The liquid ejecting head 13 according to the embodiment is formed such that the nozzle-opening surface 13b becomes substantially horizontal when it is at the standby position. However, the nozzle-opening surface 13b need not be horizontal. It is sufficient that the nozzle-opening surface 13b becomes closer to horizontal in the stand-by position compared with the recording position.

The liquid ejecting head 13, when located at the recording position, performs printing by ejecting liquid in the form of droplets onto a medium S that is supported by the supporting platform 18. In the embodiment, the direction in which the medium S proceeds on the supporting platform 18 is referred to as the transport direction F, whereas the direction in which the liquid ejecting head 13 at the recording position ejects liquid is referred to as the ejecting direction J. In addition, the direction that is different from the transport direction F and the ejecting direction J is referred to as the width direction W. The liquid ejecting head 13 according to the embodiment is formed as a line head having a large number of nozzles 13a that are disposed such that the print area in the width direction W exceeds the width of a medium S (see also FIG. 2).

Next, a configuration example of the maintenance unit 31 will be described. The maintenance unit 31 includes a wiping member 32, a cap 33, a suction channel 35 that is connected to the cap 33, and a suction mechanism 36 that sucks the inside of the cap 33. When the liquid ejecting head 13 is at the standby position, the maintenance unit 31 performs maintenance operations including wiping, capping, and cleaning.

The wiping member 32 moves relative to the liquid ejecting head 13 and wipes the nozzle-opening surface 13b. This is called “wiping”. The wiping member 32 may be formed of a plate-like material that enables elastic deformation, for example, a material such as rubber or an elastomer. Alternatively, the wiping member 32 may be formed of a cloth or a porous material, such as a non-woven fabric, that are capable of absorbing liquid.

As illustrated with the dash-dot-dot line in FIG. 1, capping is performed when the cap 33 is positioned under the liquid ejecting head 13. In performing capping, the cap 33 is raised such that the cap 33 and the nozzle-opening surface 13b form a closed space in which the nozzles 13a open. Capping is performed when the liquid ejecting head 13 suspends liquid ejecting operation, including when the power is off, in order to prevent the nozzles 13a from drying.

When the suction mechanism 36 is actuated during the capping, the pressure in the closed space where the nozzles 13a open becomes negative, which causes liquid and foreign matter, such as air bubbles, remaining in the liquid ejecting head 13 to be discharged from the nozzles 13a. This is called “suction cleaning”. In addition, cleaning while liquid is discharged from the liquid ejecting head 13 by the pressure applied by the pressurizing mechanism 22 is called “pressurized cleaning”. The suction cleaning and the pressurized cleaning constitute types of cleaning operation.

Wiping may be performed while the nozzle-opening surface 13b is in the wet state. For this purpose, the nozzles 13a discharges liquid in response to the pressure applied by the pressurizing mechanism 22. Wiping that is performed while pressurizing the inside of the nozzles 13a is called “pressurized wiping”.

In the supply flow path 21, an upstream on-off valve 37 and a downstream on-off valve 38 may be disposed upstream and downstream of the liquid chamber 23, respectively. In this case, when the pressurizing mechanism 22 applies a pressure, the drive mechanism 25 is preferably actuated with the supply flow path 21 being closed by the upstream on-off valve 37 and the downstream on-off valve 38. The downstream on-off valve 38 subsequently opens the supply flow path 21 so as to propagate the pressure loading downstream. With this configuration, an abrupt pressure change causes foreign matter such as bubbles in the flow channel to be discharged efficiently.

In the case that the liquid ejecting head 13 ejects different types of liquid (for example, different color inks), at least the nozzles 13a, the supply flow path 21, and the pressurizing mechanism 22 are provided for each type of liquid.

In this case, as illustrated in FIG. 2, a plurality of liquid chambers 23 are preferably arranged, when viewed in plan view, side by side in a direction (first direction X) that intersects the direction from the liquid chambers 23 toward the liquid ejecting head 13 (second direction Y). The liquid ejecting head 13 according to the embodiment is a line head having a longitudinal direction that is aligned with a direction (first direction X) that intersects the direction from the liquid chambers 23 toward the liquid ejecting head 13 (second direction Y) when viewed in plan view. Note that in FIG. 2, the liquid ejecting head 13 is indicated by the dash-dot-dot line when located at the recording position and also indicated by the solid line when located at the standby position.

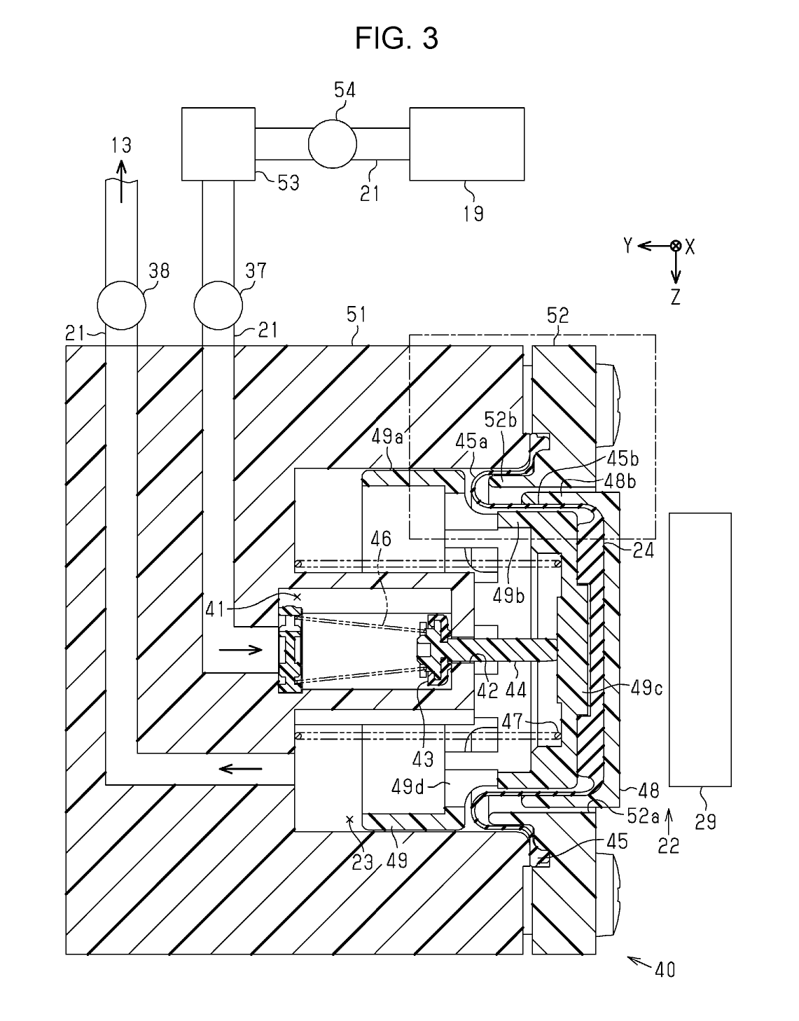

As illustrated in FIG. 3, a pressure regulation mechanism 40 may be disposed midway in the supply flow path 21. The pressure regulation mechanism 40 is formed so as to regulate the pressure in the liquid ejecting head 13. The pressure regulation mechanism 40 according to the embodiment shares some components (at least the liquid chamber 23 and the pressure-receiving portion 24) with the pressurizing mechanism 22. It is preferable that at least a portion of the pressure-receiving portion 24 be formed of a flexible member 45 capable of bending displacement.

The pressure regulation mechanism 40 includes a supply chamber 41 that is provided midway in the supply flow path 21, a liquid chamber 23 that can communicate with supply chamber 41 via a communication hole 42, a valve body 43 that can open/close the communication hole 42, and a shaft member 44 having a base end side accommodated in the supply chamber 41 and a top end side accommodated in the liquid chamber 23. The valve body 43 is formed, for example, of an elastic body that is attached to the base end of the shaft member 44.

The pressure-receiving portion 24, which is part of the wall of the liquid chamber 23, is formed of the flexible member 45 capable of bending displacement. The pressure regulation mechanism 40 also includes a first urging member 46 that is accommodated in the supply chamber 41 and a second urging member 47 that is accommodated in the liquid chamber 23. The first urging member 46 urges the valve body 43 via the shaft member 44 in the direction of closing the communication hole 42. The pressure regulation mechanism 40 may be configured so as to include only the first urging member 46 without including the second urging member 47.

The flexible member 45 pushes and displaces the shaft member 44 when the flexible member 45 is subjected to the bending displacement in the direction in which the volume of the liquid chamber 23 decreases. When the pressure in the liquid chamber 23 decreases due to, for example, the nozzles 13a discharging liquid, the flexible member 45 is bent and displaced in the direction in which the volume of the liquid chamber 23 decreases. If the pressure applied on the flexible member 45 from inside (internal pressure) decreases to less than the pressure applied from outside (external pressure) and the difference between the internal pressure and the external pressure becomes equal to or larger than a predetermined value (for example, 1 kPa), then the shaft member 44 is displaced to cause the valve body 43 to open the supply flow path 21.

In this case, the predetermined value is a value determined in accordance with urging forces of the first urging member 46 and the second urging member 47, a force required to displace the flexible member 45, a pressing force (i.e., sealing load) required for the valve body 43 to close the communication hole 42, a pressure in the supply chamber 41 acting on the surface of the valve body 43 and a portion of the shaft member 44 located within the supply chamber 41, and a pressure in the liquid chamber 23. In short, the larger the total urging force of the first urging member 46 and the second urging member 47, the larger the predetermined value. The total urging force of the first urging member 46 and the second urging member 47 is set, for example, at a value at which the pressure in the liquid chamber 23 becomes negative (for example, −1 kPa in the case that atmospheric pressure acts on the outer surface of the flexible member 45) within a range that enables meniscus formation at the gas-liquid interface in a nozzle 13a (see FIG. 1).

When the communication hole 42 is opened and liquid flows from the supply chamber 41 into the liquid chamber 23, the internal pressure in the liquid chamber 23 increases. Subsequently, when the internal pressure of the liquid chamber 23 reaches approximately −1 kPa, the valve body 43 closes the communication hole 42. Thus, the pressure in the liquid ejecting head 13 is maintained at approximately −1 kPa. As described above, the valve body 43 automatically opens/closes the communication hole 42 in response to the pressure difference between the external pressure (atmospheric pressure) and the internal pressure of the liquid chamber 23. Thus, this pressure regulation mechanism 40 is classified into a group of differential pressure regulating valves (more specifically, pressure reducing valves).

The pressurizing mechanism 22 according to the embodiment is formed such that the pressing member 29 exerts a pressing force on the pressure-receiving portion 24 and displaces the flexible member 45 toward inside the liquid chamber 23 so as to force the communication hole 42 to open.

The flexible member 45 is fixed, for example, in such a manner that the periphery of the flexible member 45 is pinched between a flow-channel forming member 51, in which the liquid chamber 23 is formed, and a fixation member 52, in which a cylindrical through hole 52a is formed. The flexible member 45 can be formed of an elastic material such as elastomer (for example, rubber such as butyl rubber). The flexible member 45 has a bent portion 45a that extends from the periphery toward the center of the flexible member 45. The bent portion 45a is bent in such a manner that it extends from the periphery of the flexible member 45 and enters the liquid chamber 23 where the bent portion 45a is turned around and directed toward outside the liquid chamber 23. The central part of the flexible member 45 is shaped like a disk, which functions as the pressure-receiving portion 24. In the flexible member 45, the portion between the bent portion 45a and the pressure-receiving portion 24 forms a cylindrical portion 45b, which is shaped like a cylinder. It is preferable that the fixation member 52 have a protruding portion 52b that protrudes so as to hold the periphery of the bent portion 45a and to extend the through hole 52a toward the bottom of the liquid chamber 23.

A pressure-receiving member 48 is preferably disposed on the outer side of the flexible member 45 so as to cover the pressure-receiving portion 24 and the cylindrical portion 45b. The pressure-receiving member 48 preferably has a cylindrically-shaped side wall 48b that comes to a position between the cylindrical portion 45b and the through hole 52a. It is preferable that the pressure-receiving member 48 have a smaller coefficient of friction with the through hole 52a than the flexible member 45. For example, in the case that the flexible member 45 is formed of an elastic material such as butyl rubber, the pressure-receiving member 48 formed of resin can reduce the frictional resistance of the flexible member 45 that displaces against the through hole 52a. The material of the pressure-receiving member 48 is not limited to resin. However, it is preferable that the pressure-receiving member 48 be formed of a material that can provide a smoother surface and be more resistant to elastic deformation than the flexible member 45.

When the pressure-receiving member 48 is referred to as a first pressure-receiving member 48, a second pressure-receiving member 49 may be provided in the liquid chamber 23. The second pressure-receiving member 49 has a small-diameter cylindrical portion 49b that is cylindrically shaped and positioned so as to overlap the internal surface of the cylindrical portion 45b, a disk portion 49c that is positioned at an end of the small-diameter cylindrical portion 49b so as to overlap the pressure-receiving portion 24, and a large-diameter cylindrical portion 49a that has a diameter larger than that of the small-diameter cylindrical portion 49b. It is preferable that the second pressure-receiving member 49 have a circulation hole 49d for liquid circulation that is formed, for example, at the large-diameter cylindrical portion 49a.

In the case that the pressure-receiving members 48 and 49 are provided, the pressing member 29 presses the pressure-receiving portion 24 via the first pressure-receiving member 48. The pressing member 29 thereby bends and displaces the flexible member 45 and presses the shaft member 44 via the pressure-receiving portion 24 and the second pressure-receiving member 49. As a result, the supply flow path 21 (communication hole 42) is opened by the valve body 43, which is positioned in the supply chamber 41 that is upstream of the liquid chamber 23. Thus, the valve body 43 opens/closes the supply flow path 21 in conjunction with the displacement of the flexible member 45.

In this operation, displacing the flexible member 45 toward inside the liquid chamber 23 pressurizes the liquid chamber 23, causing the bent portion 45a to expand outward. As a result, the bent portion 45a may stick to the pressure-receiving member 48 or the protruding portion 52b. Such sticking to these components may hamper displacement of the flexible member 45 in response to pressure changes.

In order to avoid this problem, a depressurizing mechanism 53 that can depressurize the liquid chamber 23 may be provided in the supply flow path 21 at a position upstream of the upstream on-off valve 37. In this case, it is preferable to install an on-off valve 54 in the supply flow path 21 at a position between the depressurizing mechanism 53 and the liquid containers 19. In addition, after the flexible member 45 is displaced toward inside the liquid chamber 23 by actuating the drive mechanism 25 (see FIG. 1), the depressurizing mechanism 53 preferably depressurizes the liquid chamber 23 while the on-off valve 54 and the downstream on-off valve 38 are closed and the upstream on-off valve 37 is open.

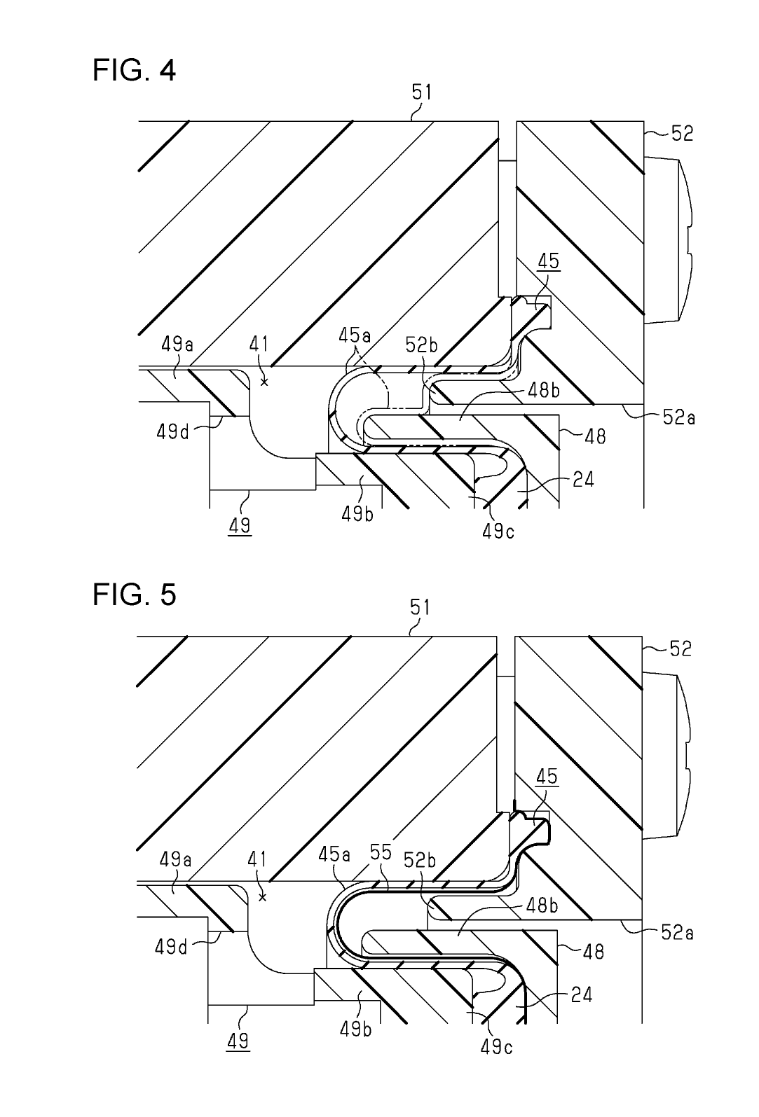

As a result, the bent portion 45a, which has been expanded outward due to the pressurization as illustrated with the dash-dot-dot line in FIG. 4, is drawn toward inside the liquid chamber 23 as illustrated with the solid line in FIG. 4. This pulls off the flexible member 45 that has stuck to the pressure-receiving member 48 or the protruding portion 52b. Note that the depressurizing mechanism 53 may be provided between the downstream on-off valve 38 and the liquid chamber 23.

As an alternative measure to avoid sticking, instead of providing the depressurizing mechanism 53 and the on-off valve 54, the liquid ejecting head 13 may eject liquid while the upstream on-off valve 37 is closed and the downstream on-off valve 38 is open. Consequently, the pressure in the liquid chamber 23 drops due to liquid ejection, which prevents the flexible member 45 from sticking. In this case, when the pressing member 29 stops pressing, the downstream on-off valve 38 is preferably closed. This reduces the occurrence of ejection trouble of a nozzle 13a, which is induced when the nozzle 13a sucks gas.

As another alternative measure to avoid sticking of the flexible member 45, a sheet 55 having a coefficient of friction smaller than that of the flexible member 45 may be provided between the flexible member 45 and the pressure-receiving member 48, as illustrated in FIG. 5. With this configuration, the flexible member 45, which tries to expand due to the pressurization, does not tend to stick even when the flexible member 45 comes into contact with the pressure-receiving member 48 or the protruding portion 52b. Alternatively, instead of providing the sheet 55, the outer surface of the flexible member 45 may have a coating so as to lower the coefficient of friction of the outer surface. In this case, the coefficient of friction of the coating is preferably less than one.

Next, operational advantages of the liquid ejecting apparatus 11 according to the embodiment will be described. When viewed in plan view, the liquid chamber 23 and the liquid ejecting head 13 are arranged adjacent to each other. Moreover, the liquid ejecting head 13 is provided on one side with respect to the liquid chamber 23 and the pressure-receiving portion 24 is provided on the other side. As a result, disposition of the drive mechanism 25 becomes more flexible. For example, when the drive mechanism 25 is provided together with the liquid ejecting head 13 and the liquid chamber 23 in a row in one direction, the space above or below the liquid ejecting head 13 can be utilized for different purposes, or the height of the housing 12 can be reduced.

When the liquid ejecting head 13 moves from the standby position to the recording position, the liquid ejecting head 13 moves in a direction away from the pressure-receiving portion 24. Thus, the space in which the liquid ejecting head 13 is disposed can be separated from the space in which the drive mechanism 25 is disposed. In particular, when the liquid ejecting head 13 moves between the standby position and the recording position, this movement includes a horizontal component. Thus, the drive mechanism 25 can be disposed at a position horizontally separated from the region in which the liquid ejecting head 13 moves.

The embodiment described above may be modified into modification examples described below. Elements included in the embodiment can be arbitrarily combined with elements included in any one of modification examples described below. Moreover, the elements included in the modification examples can be arbitrarily combined with each other. Note that in the description below, the same reference numeral is given to an element having a function similar to that of an element previously described, and duplicated description is thereby omitted.

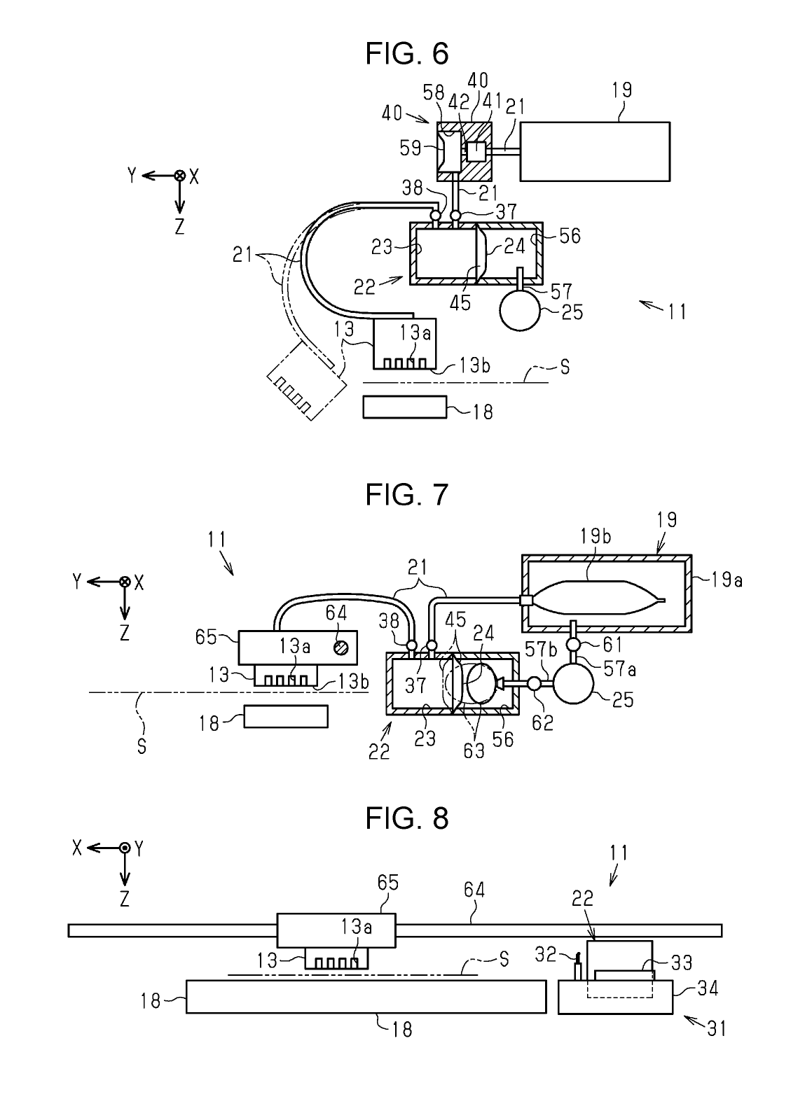

The liquid ejecting head 13, which is a line head, may be fixed at the recording position, instead of moving between the recording position and the standby position. As illustrated in the liquid ejecting head 13 according to a first modification example in FIG. 6, the nozzle-opening surface 13b is inclined with respect to the horizontal plane when it is at the standby position. When it is at the recording position, the nozzle-opening surface 13b may become closer to horizontal than it is at the recording position.

As in the first modification example in FIG. 6, the pressure regulation mechanism 40 is provided separately from the pressurizing mechanism 22. In this case, the pressure regulation mechanism 40 includes a separate liquid chamber 58 capable of communicating with the supply chamber 41 via the communication hole 42, and also includes a flexible member 59 constituting a portion of the wall of the liquid chamber 58. Note that illustration of the detailed structure (for example, the shaft member 44 and the valve body 43) of the pressure regulation mechanism 40 is omitted in FIG. 6.

In the case that a plurality of components (for example, the pressure-receiving portion 24, liquid chamber 23, and the liquid ejecting head 13) are arranged in a row in one direction (for example, the second direction Y) when viewed in plan view, portions of these components may overlap each other in the gravity direction. For example, as in the first modification example in FIG. 6, the liquid ejecting head 13 may be positioned below the level of the liquid chamber 23, and a portion of the liquid ejecting head 13 may overlap the liquid chamber 23 in the vertical direction. Moreover, the drive mechanism 25 may be disposed below the level of the liquid chamber 23.

The drive mechanism 25 may be configured such that the flexible member 45 is bent and displaced by air pressure. For example, as in the first modification example in FIG. 6, the liquid chamber 23 and a pressurizing chamber 56 are partitioned by the flexible member 45, and a supply pump, which serves as a drive mechanism 25, delivers gas to the pressurizing chamber 56 via a supply pipe 57. According to this configuration, when the drive mechanism 25 pressurizes the pressurizing chamber 56 by delivering air, the air pressure can displace the flexible member 45 toward inside the liquid chamber 23.

As in the second modification example in FIG. 7, the liquid container 19 includes a case 19a and a liquid-containing pouch 19b that is accommodated in the case 19a. By pressurizing the inside of the case 19a by air, the liquid container 19 may supply liquid in the liquid-containing pouch 19b to the liquid ejecting head 13. In this case, the supply pump (i.e., drive mechanism 25) for supplying gas to the pressurizing chamber 56, which is separated from the liquid chamber 23 by the flexible member 45, can be used as a supply pump for delivering gas to the case 19a. In this case, it is preferable that an on-off valve 61 be disposed in a supply pipe 57a connected to the case 19a and an on-off valve 62 be disposed in a supply pipe 57b connected to the pressurizing chamber 56.

As in the second modification example in FIG. 7, the pressurizing mechanism 22 may have a gas pouch 63 that contains gas delivered through the supply pipe 57b. In this case, it is preferable that the gas pouch 63 be inflated by delivering gas into the gas pouch 63 and the inflated gas pouch 63 push the flexible member 45.

As in the second modification example in FIG. 7 and FIG. 8, the liquid ejecting apparatus 11 may include a carriage 65 that reciprocally moves with the liquid ejecting head 13 being held thereon and a guide shaft 64 that guides the movement of the carriage 65. In the liquid ejecting apparatus 11, the supporting platform 18 may be disposed near the center of a movement region in which the carriage 65 moves. In this case, as illustrated in FIG. 8, the supporting platform 18 and the maintenance unit 31 are arranged side by side in the movement direction of the carriage 65 (for example, the first direction X). In the movement direction (the first direction X), the recording position of the liquid ejecting head 13 is disposed above the supporting platform 18 and the standby position of the liquid ejecting head 13 is disposed above the maintenance unit 31. The second direction Y corresponds to the transport direction of media S. In this case, it is preferable that the liquid chamber 23 be disposed, for example, behind the movement region of the liquid ejecting head 13 (i.e., at a position upstream of the supporting platform 18 or the maintenance unit 31 in the transport direction). In addition, the pressure-receiving portion 24 (the flexible member 45) is preferably disposed in a rear portion (i.e., an upstream portion in the transport direction) of the liquid chamber 23. Alternatively, the liquid chamber 23 may be disposed, for example, in front of the movement region of the liquid ejecting head 13 (i.e., at a position downstream of the supporting platform 18 or the maintenance unit 31 in the transport direction), and the pressure-receiving portion 24 (the flexible member 45) may be disposed in a front portion (i.e., a downstream portion in the transport direction) of the liquid chamber 23.

The liquid that the liquid ejecting head 13 ejects is not limited to ink, but may be, for example, a liquid-state material made by dispersing or mixing particles of a functioning material in liquid. For example, the liquid ejecting apparatus 11 may be configured so as to perform recording by ejecting a liquid-state material that contains, in the form of a dispersion or melt, an electrode material, a coloring material (pixel material), etc., to be used for manufacturing liquid crystal displays, Electro Luminescence (EL) displays, surface light emission displays, etc.

The medium S is not limited to a sheet of paper but may be a plastic film, a thin board material, etc., or may be a piece of cloth to be used for a cloth-printing apparatus, etc. Moreover, the medium S may be an arbitrarily-shaped piece of clothing or the like, such as a T-shirt, or may be an arbitrarily-shaped three-dimensional object, such as a piece of tableware or stationery.

Technical ideas involved in the embodiment and modification examples above as well as advantageous effects thereof are as follows.
Technical Idea 1: a liquid ejecting apparatus that includes a liquid ejecting head that has nozzles and is formed to eject liquid from the nozzles, a supply flow path that is configured to supply the liquid to the liquid ejecting head, and a pressurizing mechanism that has a liquid chamber disposed in the middle of the supply flow path and a pressure-receiving portion constituting a portion of a wall of the liquid chamber, the pressurizing mechanism being configured to pressurize a region downstream of the liquid chamber when the pressure-receiving portion receives an external force, wherein the liquid chamber is arranged side by side with the liquid ejecting head in a state where the pressure-receiving portion is positioned on an opposite side of the liquid ejecting head when viewed in plan view from above.

According to this configuration, the pressure-receiving portion is disposed on the side opposite to the liquid ejecting head. Consequently, the position of a mechanism that applies an external force to the pressure-receiving portion is not limited to a position directly above or directly below the liquid ejecting head. This leads to a higher degree of freedom in component arrangement.

Technical Idea 2: the liquid ejecting apparatus according to Technical Idea 1, wherein the liquid ejecting head is movable between a recording position at which the liquid ejecting head ejects the liquid onto a medium and a standby position that is closer to the liquid chamber than to the recording position, and the standby position is located between the pressure-receiving portion and the recording position when viewed in plan view from above.

With this configuration, the mechanism that applies an external force to the pressure-receiving portion can be disposed, when viewed in plan view, at a position distant from the movement path of the liquid ejecting head.
Technical Idea 3: the liquid ejecting apparatus according to Technical Idea 2, wherein the liquid ejecting head has a nozzle-opening surface on which the nozzles open and is formed to be rotatable between the recording position and the standby position, and the nozzle-opening surface inclines with respect to a horizontal plane at the recording position and is closer to horizontal at the standby position.

With this configuration, the liquid ejecting head can be moved efficiently by means of rotation.
Technical Idea 4: the liquid ejecting apparatus according to any one of Technical Ideas 1 to 3, further including a plurality of the liquid chambers that are arranged side by side in a direction that intersects a direction from the liquid chambers toward the liquid ejecting head when viewed in plan view from above.

With this configuration, the liquid ejecting head can be arranged adjacent to a plurality of the liquid chambers on a plane.
Technical Idea 5: the liquid ejecting apparatus according to any one of Technical Ideas 1 to 4, wherein the liquid ejecting head is a line head in which a direction intersecting a direction from the liquid chamber toward the liquid ejecting head is a longitudinal direction when viewed in plan view from above.

With this configuration, the long liquid ejecting head can be arranged adjacent to the liquid chamber on a plane.
Technical Idea 6: the liquid ejecting apparatus according to any one of Technical Ideas 1 to 5, further including a drive mechanism capable of applying an external force to the pressure-receiving portion, the drive mechanism being disposed on a side opposite to the liquid chamber with respect to the pressure-receiving portion when viewed in plan view from above.

With this configuration, the liquid ejecting head, the liquid chambers, and the drive mechanism can be arranged adjacent to each other on a plane.
Technical Idea 7: the liquid ejecting apparatus according to Technical Idea 6, wherein at least a part of the pressure-receiving portion is formed by a flexible member which is displaceable, and the drive mechanism can apply a pressing force to the pressure-receiving portion so that the flexible member is displaced toward inside the liquid chamber.

With this configuration, a region downstream of the liquid chamber can be pressurized by a pressing force displacing the flexible member toward inside the liquid chamber.
Technical Idea 8: the liquid ejecting apparatus according to Technical Idea 6, wherein at least a part of the pressure-receiving portion is formed by a flexible member, and the drive mechanism is capable of displacing the flexible member by air pressure.

With this configuration, a region downstream of the liquid chamber can be pressurized by displacing the flexible member toward inside the liquid chamber by air pressure.
Technical Idea 9: the liquid ejecting apparatus according to Technical Idea 7 or 8, further including a valve body that can open/close the supply flow path at a position upstream from the liquid chamber, wherein the valve body opens/closes the supply flow path in conjunction with displacement of the flexible member.

With this configuration, the valve body opens/closes the supply flow path in response to pressure changes inside the supply flow path, which can regulate the pressure inside the liquid ejecting head. The liquid chamber used for the pressure regulation is shared by the pressurizing mechanism, which can simplify the configuration of flow channels.

Technical Idea 10: the liquid ejecting apparatus according to any one of Technical Ideas 7 to 9, further including a pressure-receiving member that is disposed on an outer side of the flexible member and a depressurizing mechanism capable of depressurizing the liquid chamber, wherein the depressurizing mechanism depressurizes the liquid chamber after the drive mechanism displaces the flexible member toward inside the liquid chamber.

Displacing the flexible member toward inside the liquid chamber pressurizes the liquid chamber, causing the flexible member to expand outward. As a result, the flexible member may stick to the pressure-receiving member. This may hamper displacement of the flexible member in response to pressure changes. However, with this configuration, when the depressurizing mechanism depressurizes the liquid chamber that has been pressurized, the flexible member is drawn toward inside the liquid chamber and detached from the pressure-receiving member.

Technical Idea 11: the liquid ejecting apparatus according to any one of Technical Ideas 7 to 9, further including a pressure-receiving member that is disposed on an outer side of the flexible member and a sheet that is disposed between the flexible member and the pressure-receiving member, wherein the sheet has a coefficient of friction smaller than that of the flexible member.

Displacing the flexible member toward inside the liquid chamber pressurizes the liquid chamber, causing the flexible member to expand outward. As a result, the flexible member may stick to the pressure-receiving member. This may hamper displacement of the flexible member in response to pressure changes. However, with this configuration, placing a sheet having a small coefficient of friction between the pressure-receiving member and the flexible member can restrain the flexible member from sticking to the pressure-receiving member.

The entire disclosure of Japanese Patent Application No. 2017-003966, filed Jan. 13, 2017 is expressly incorporated by reference herein.

What is claimed is:

1. A liquid ejecting apparatus, comprising:
a liquid ejecting head that has nozzles and is formed to eject liquid from the nozzles;
a supply flow path that is configured to supply the liquid to the liquid ejecting head; and
a pressurizing mechanism that has a liquid chamber disposed in the middle of the supply flow path and a pressure-receiving portion constituting a portion of a wall of the liquid chamber, the pressurizing mechanism being configured to pressurize a region downstream of the liquid chamber when the pressure-receiving portion receives an external force, wherein the liquid chamber is arranged side by side with the liquid ejecting head in a state where the pressure-receiving portion is positioned on an opposite side of the liquid ejecting head when viewed in plan view from above.

2. The liquid ejecting apparatus according to claim 1, wherein
the liquid ejecting head is movable between a recording position at which the liquid ejecting head ejects the liquid onto a medium and a standby position that is closer to the liquid chamber than to the recording position, and
the standby position is located between the pressure-receiving portion and the recording position when viewed in plan view from above.

3. The liquid ejecting apparatus according to claim 2, wherein
the liquid ejecting head has a nozzle-opening surface on which the nozzles open and is formed to be rotatable between the recording position and the standby position, and
the nozzle-opening surface inclines with respect to a horizontal plane at the recording position and is closer to horizontal at the standby position.

4. The liquid ejecting apparatus according to claim 1, further comprising:
a plurality of the liquid chambers that are arranged side by side in a direction that intersects a direction from the liquid chambers toward the liquid ejecting head when viewed in plan view from above.

5. The liquid ejecting apparatus according to claim 1, wherein
the liquid ejecting head is a line head in which a direction intersecting a direction from the liquid chamber toward the liquid ejecting head is a longitudinal direction when viewed in plan view from above.

6. The liquid ejecting apparatus according to claim 1, further comprising:
a drive mechanism capable of applying an external force to the pressure-receiving portion, the drive mechanism being disposed on a side opposite to the liquid chamber with respect to the pressure-receiving portion when viewed in plan view from above.

7. The liquid ejecting apparatus according to claim 6, wherein
at least a part of the pressure-receiving portion is formed by a flexible member which is displaceable, and
the drive mechanism can apply a pressing force to the pressure-receiving portion so that the flexible member is displaced toward inside the liquid chamber.

8. The liquid ejecting apparatus according to claim 6, wherein
at least a part of the pressure-receiving portion is formed by a flexible member, and
the drive mechanism is capable of displacing the flexible member by using air pressure.

9. The liquid ejecting apparatus according to claim 7, further comprising:
a valve body that can open/close the supply flow path at a position upstream from the liquid chamber, wherein
the valve body opens/closes the supply flow path in conjunction with displacement of the flexible member.

10. The liquid ejecting apparatus according to claim 7, further comprising:
a pressure-receiving member that is disposed on an outer side of the flexible member and a depressurizing mechanism capable of depressurizing the liquid chamber, wherein
the depressurizing mechanism depressurizes the liquid chamber after the drive mechanism displaces the flexible member toward inside the liquid chamber.

11. The liquid ejecting apparatus according to claim 7, further comprising:
a pressure-receiving member that is disposed on an outer side of the flexible member and a sheet that is disposed between the flexible member and the pressure-receiving member, wherein
the sheet has a coefficient of friction smaller than that of the flexible member.
